(19) United States
(12) Patent Application Publication
(10) Pub. No.: US 2024/0251712 A1
(43) Pub. Date: Aug. 1, 2024

(54) FLEX SEALS FOR GRAIN HEADERS

(71) Applicant: Reitzel Tractor LLC, Edon, OH (US)

(72) Inventor: Ken REITZEL, Edon, OH (US)

(21) Appl. No.: 18/423,384

(22) Filed: Jan. 26, 2024

Related U.S. Application Data
(60) Provisional application No. 63/442,501, filed on Feb. 1, 2023.

(51) Int. Cl. A01D 41/14

(52) U.S. Cl. CPC A01D 41/14

(57) ABSTRACT

Systems and methods for securing sill plates in grain header attachments for combine harvesters. A generally triangular sill plate seal includes a bolt through hole for securing the seal to a sill plate using existing bolt holes. The seal is then joined to the sill plate at securing holes located at the vertices of the seal using a fusing method such as welding or brazing. The systems and methods disclosed may be applied to new headers or adapted to existing headers.

### CROSS REFERENCE TO RELATED APPLICATIONS

This application is related to and claims priority to U.S. Provisional Patent Application No. 63/442,501 filed on Feb. 1, 2023.

### FIELD OF THE INVENTION

The claimed technology relates generally to agricultural equipment and more particularly to seals used in grain head attachments for combine harvesters.

### BACKGROUND

Cereal grain crops such as wheat, soybeans, oats, and the like may be harvested using a combine harvester equipped with a grain head such as shown in FIGS. 1-2. A grain header 10 includes a reel 12 which is a series of bars equipped with a plurality of fingers or teeth 22 which gather and temporarily hold in place the stalks of the crop being harvested so that an oscillating cutter bar 16 can cut the stalks of the crop. The reel 12 then moves the crop stalks into the header 10 where they collect and are moved towards the center of the head 10 to be drawn into the combine harvester for processing (separating the grain which is collected from the stalks and chaff which are expelled onto the ground). Grain heads typically are categorized as either a draper header (not shown) which use a belt to convey the cut grain stalks towards the center of the header and auger headers (shown in FIGS. 1-2) which have a rotating auger 14. After being cut crop stalks pass over sill plates 18 which are secured in place by shoulder bolts 20. The sill plates form a portion of the floor of the header 10 where the crop stalks are collected and moved towards the center of the header 10 by the auger 14.

The sill plates 18 are subjected to oscillating forces created by operation of the flexible cutting bar 16, flexure of the header 10 caused by the combine harvester driving over uneven terrain, and flexure of some grain headers 10 which are designed to flex to better follow the contours of a field. The oscillation of the sill plates generates repeating forces between the head of the shoulder bolts 20 and the opening in the sill plates 18 through which the bolts 20 pass. Over time, these oscillating forces deform and may even tear the sill plates which can create catch points where crop stalks can collect and potentially clog the header. If enough bolts 20 tear out a plate 18 may come loose and potentially be swept into the combine harvester potentially causing significant damage to the equipment as well as causing downtime for repairs. Many manufacturers of such grain heads recommend regular inspection of the sill plates and the shoulder bolts which hold them in place as well as replacement of the shoulder bolts on an annual basis. The design of the system to hold the sill plates in place has ample room for improvement.

### SUMMARY

In one aspect, improved flex seal systems for combine harvester header attachments which include a triangular seal plate having a longer edge and two shorter edges, a securing through hole located near each vertex, and a bolt hole located between two vertices along the longer edge, a shoulder bolt having a head portion and a shoulder portion where the seal plate bolt hole is sized so as to prevent the bolt head portion from passing through the bolt hole but allows the shoulder portion to pass through. The system may also include a washer sized to have a diameter greater than the head portion of the bolt and so as to allow the shoulder portion to pass therethrough. Optionally the seal plate may be coated with paint, epoxy, and/or plastic to prevent corrosion. The vertices of the triangular seal plate may be rounder or contoured. The triangular seal plate may be made from a metal which may be metallurgically fused to the sill plate such as by welding, brazing, and soldering.

In another aspect, a method of securing a sill plate in a header attachment for a combine harvester is provided which includes providing a triangular seal plate having a longer edge and two shorter edges, a securing through hole located near each vertex, and a bolt hole located between two vertices along the longer edge, providing a shoulder bolt having a head portion and a shoulder portion, positioning the seal plate such that the seal plate bolt hole aligns with an existing bolt hole through the sill plate of a combine harvester header, passing the shoulder portion of the shoulder bolt through the seal plate bolt hole and securing the shoulder bolt to the sill plate bolt hole, and metallurgical joining the seal plate to the sill plate at each securing through hole in the seal plate. The metallurgical joining may be one or more of welding, brazing, and soldering. The method may also include a washer disposed between the shoulder bolt and the seal plate. Optionally the seal plate may be coated with paint, epoxy, and/or plastic to prevent corrosion. The method may also include removal of an existing bolt from a sill plate prior to positioning of the seal plate.

In a further aspect, a sill plate seal system for a grain header attachment of a combine harvester having a triangular seal plate having a first edge which is longer than the second and third edges, a through hole located near each vertex, and a bolt hole located along the first edge, and a shoulder bolt having a head portion and a shoulder portion, where the seal plate bolt hole is sized so as to prevent the bolt head portion from passing therethrough and to allow the shoulder portion of the bolt to pass therethrough. Optionally, the bolt hole is an oblong slot or a round hole. A washer may be disposed between the shoulder bolt and seal plate. The surface of the seal plate may be coated with one or more of paint, epoxy, and plastic to prevent corrosion. The vertices of the triangular seal plate may be rounded. The triangular seal plate may be made from a metal which may be metallurgically fused to the sill plate such as by welding, brazing, and soldering.

### BRIEF DESCRIPTION OF THE DRAWINGS

FIG. 1 is a perspective view of an unmodified grain head attachment for a combine harvester according to the prior art;

FIG. 2 is another perspective view of an unmodified grain head attachment for a combine harvester according to the prior art;

FIG. 3 is top perspective view of a sill on a grain head attachment with the hold down bolt removed;

FIG. 4 is a top perspective view of a sill on a grain head attachment with an improved seal according to one embedment of the disclosed invention;

FIG. 5 is top perspective view of a sill on a grain head attachment with improved seals according to one embedment of the disclosed invention;

FIG. 6 shows an improved sill seal according to one embedment of the disclosed invention;

FIG. 7 shows an example of a shoulder bolt for use with the improved sill seals according to the disclosed invention;

FIG. 8 shows a kit of improved sill seals according to one embodiment of the disclosed invention;

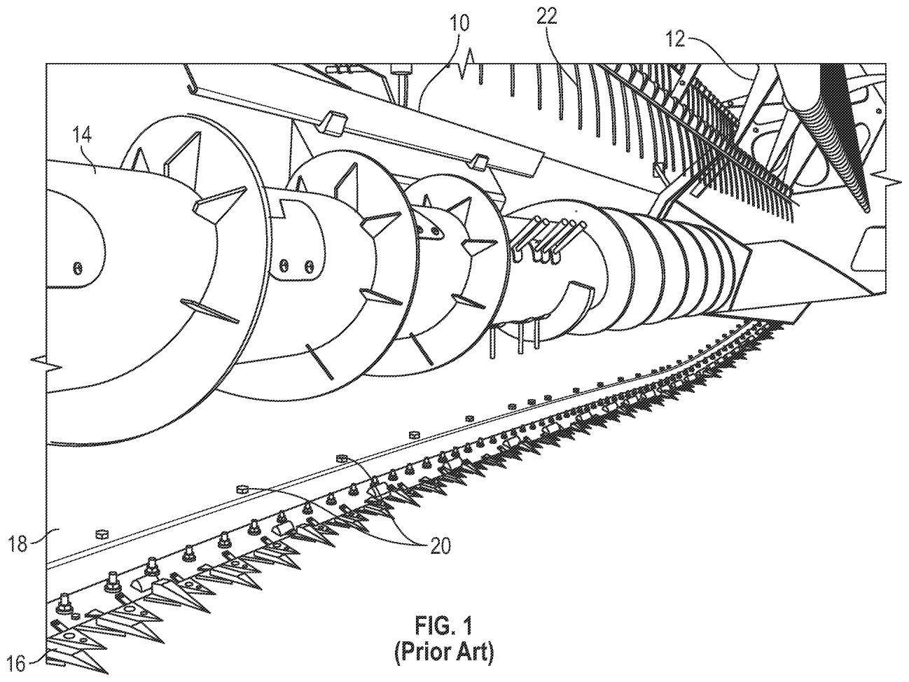

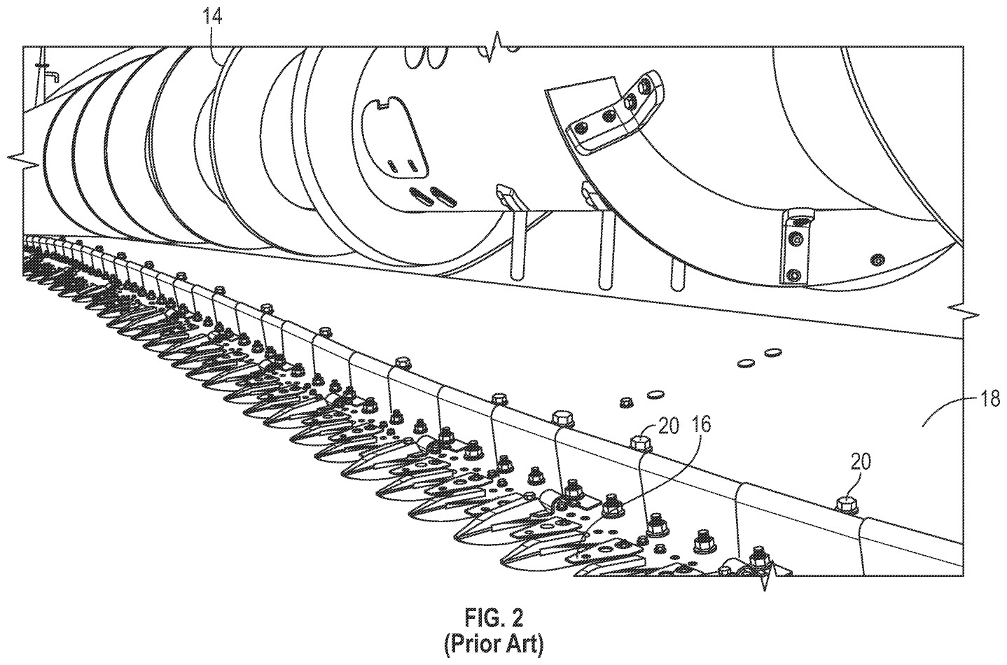

### DESCRIPTION

For the purposes of promoting an understanding of the principles of the claimed technology and presenting its currently understood best mode of operation, reference will now be made to the embodiments illustrated in the drawings and specific language will be used to describe the same. It will nevertheless be understood that no limitation of the scope of the claimed technology is thereby intended, with such alterations and further modifications in the illustrated device and such further applications of the principles of the claimed technology as illustrated therein being contemplated as would normally occur to one skilled in the art to which the claimed technology relates.

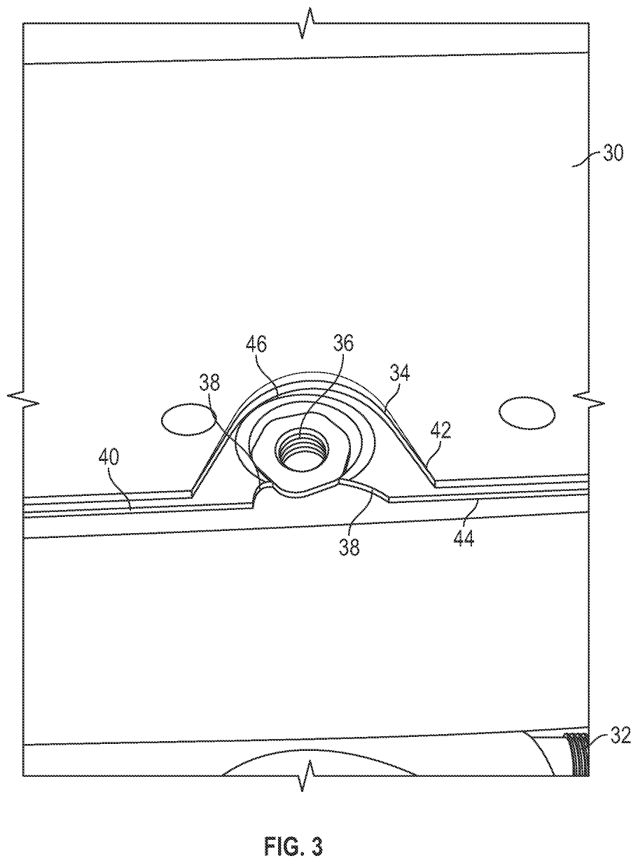

FIG. 3 shows a perspective view of a sill plate 30 and a cutter bar 32 of a grain header. In this example, the shoulder bolt which is used to seal the edge 40 of the sill plate 30 down has been removed for clarity. In this example, the sill plate 30 has a cut out 34 in an upper layer 42 having a truncated triangular shape and a hole 46 cut through a lower layer 40. A threaded nut 36 is disposed below the sill plate 30 into which a shoulder bolt may be threaded to secure the sill plate 30 to the header. Shoulder bolts are typically used in this setting as the unthreaded shoulder of the bolt allows the sill plate 30 to flex up and down to some degree while the head acting against the upper layer 42 and/or lower layer 40 prevents the sill plate 30 from flexing too much and potentially creating a gap between the sill plate 30 and the header.

Existing sill plate 30 sealing methods such as using only a shoulder bolt or bolts to secure the sill plate 30 can cause failure in the sill plate as previously discussed. As shown in FIG. 3, one example of such failure can be the tearing of the sill plate 30 at or around the shoulder bolt as the sill plate 30 is repeatedly forced against the bolt head causing metal fatigue and eventually failure. In this example, the lower layer 40 has torn creating ragged edges 38 which creates a catch point for crop material to become lodged, collect, and potentially create clogs in the header. If enough of the bolts in a particular sill plate tear out the plate may come loose and potentially be swept into the combine harvester.

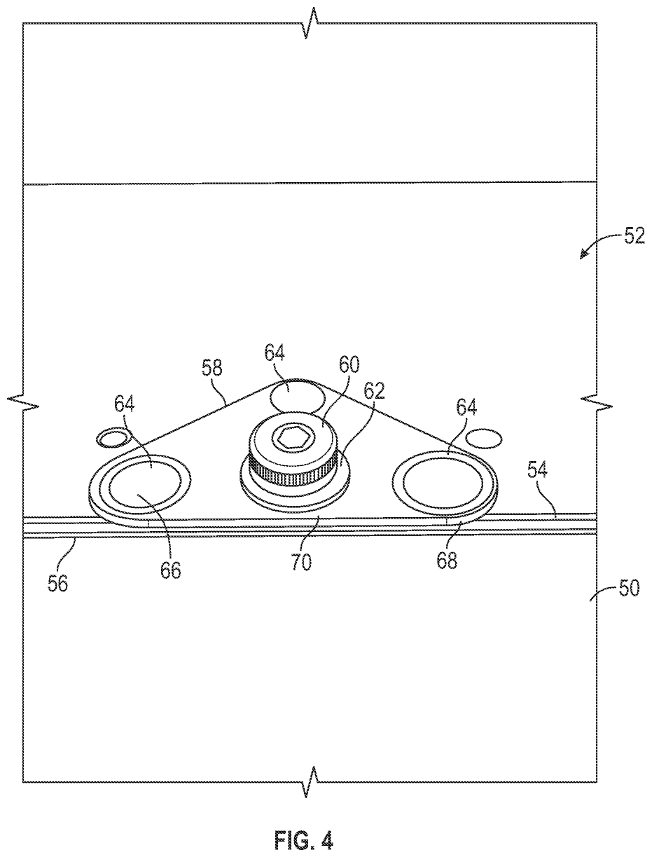

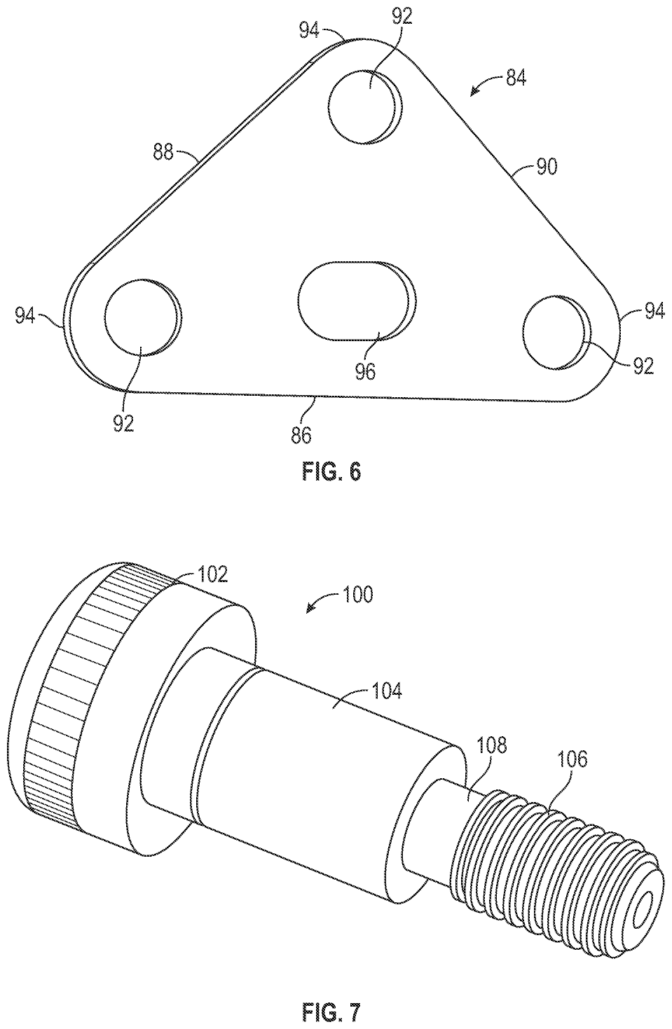

Damaged sill plates 30 may be salvaged and undamaged sill plates 52, on both reel and draper style headers, may be better secured and have their useful life extended by using the improved sill plate seal devices 58 described herein. FIG. 4 shows one example of an improved sill plate seal 58 according to the disclosed invention. In this particular example, a sill plate seal 58 having a generally triangular shape is shown. The sill plate seal 58 has a securing through hole 64 located near each corner 68 of the seal 58. The seal 58 also includes a through hole (visible in the example shown in FIG. 6) through which a shoulder bolt 60 may pass and be secured to the existing bolt hole or other threaded securing feature of the header. Optionally, a washer 62 may be disposed between the shoulder bolt 60 and seal 58 so as to allow oscillating forces between the bolt 60 and the seal 58 to act over a larger area. The seal 58 is positioned such that a linear edge 70 of the generally triangular shaped seal 58 faces forward (i.e., towards the cutting bar) so as not to create a potential catch point for crops passing over the sill plate 58.

The seal 58 may be secured to the sill plate 52 surface at each securing through hole 64 such as by welding, brazing, soldering, or other suitable metallurgical methods of joining metal to metal. Using mechanical methods to join the seal to the sill plate such as screws or rivets are less desirable as this simply generates new points of potential mechanical failure such as those previously described. By using metallurgical methods of jointing the seal to the sill plate such potential areas of mechanical weakness and failure are avoided. If the metallurgical joint fails (e.g., a weld breaks) the underlying sill plate will be undamaged and the failed joint can be cleaned and repaired.

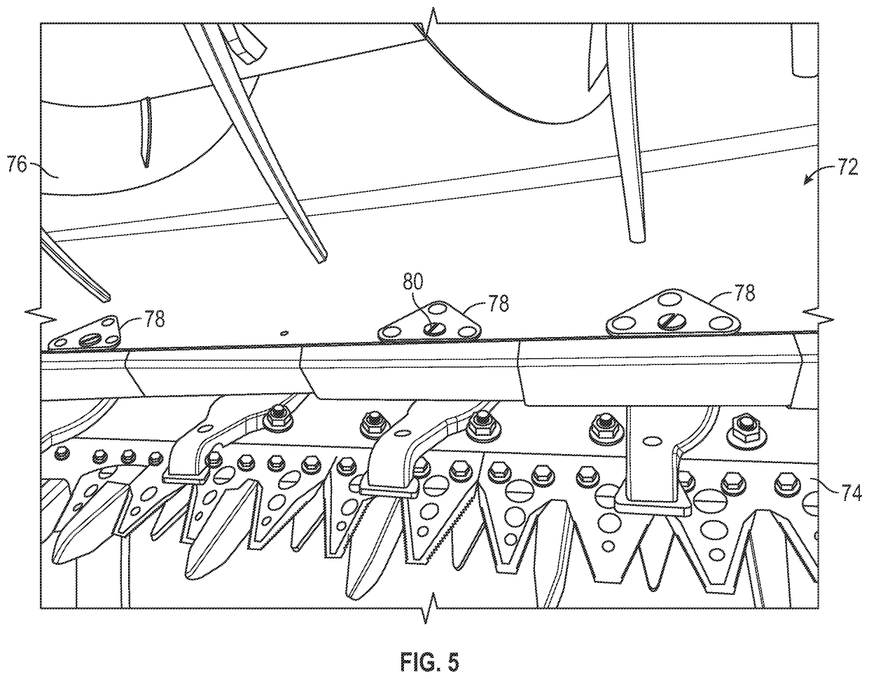

FIG. 5 shows a plurality of sill plate seals 78 according to another example of the disclosed invention. This view shows the typical placement of the seals 78 relative to the cutting bar 74 in a grain header 76. In this particular example the sill plates 72 are held down at the seals 78 using shoulder bolts 80 having slotted heads. In the example shown in FIG. 4, the shoulder bolts 60 used internal hex-drive heads. In other examples bolts having other drive types such as star drive, square or Robertson drive, Phillips drive, hex head or other external-drive configurations, or any other suitable drive method may be used.

FIG. 6 shows another example of a sill plate seal 84 according to an embodiment of the disclosed invention. In this particular example, the seal 84 is generally triangular in shape having a longer edge 86 designed to be the forward facing (i.e., closest to the cutter bar) and two shorter edges 88, 90 having equal length. Each vertex or corner of the triangle 94 is optionally rounded off so as to prevent a sharp angle which might act as a catch point for crop material passing over the seal 84. Located near each corner 94 is a securing through hole 92 where the seal 84 may be secured to a sill plate using one or more of the metallurgical techniques previously described. A bolt hole 96 is positioned through the body of the seal 84 at a desired location, typically roughly equidistant from the securing through holes 92. In this particular example the bolt hole is an oblong slot so as to allow some lateral flex of the seal relative to the bolt. In other examples, the bolt hole may be a round hole.

FIG. 7 shows one example of a shoulder bolt 100 which may be used in combination with the improved sill plate seals disclosed herein. Shoulder bolts 100 include a head portion 102, a shoulder portion 104, and a threaded portion 106. The threaded portion typically includes an unthreaded neck fillet 108 disposed between the shoulder portion 104 and the threaded portion 106. As previously discussed, any suitable drive mechanism may be incorporated into the head portion 102. Optionally, the outer edge of the head portion may also include knurling, ridges, or other features which allow for the bolt 100 to be tightened or loosened by hand. Such features may allow the bolts to be checked more quickly for tightness as no tool is required to see if such bolts are loose. The exact length of the head portion, shoulder portion, and threaded portion both overall and relative to one another may vary as desired and/or from header to header depending on a particular grain header's specifications.

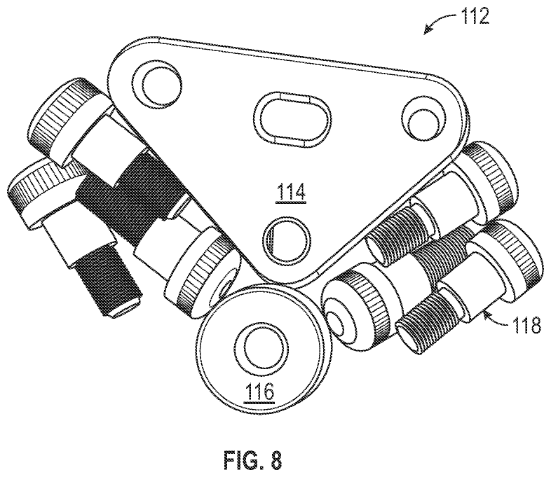

One example of a kit 112 containing improved sill plate seals 114 according to the disclosed invention is shown in FIG. 8. In this example, the kit 112 includes two sill plate seals 114, a plurality of washers 116, and six shoulder bolts 118. In other examples, such kits may contain more or fewer of each piece. In further examples, some pieces such as the bolts or the washers may be eliminated. In still other examples, kits may include a sufficient number of seals, bolts, and washers to completely retrofit a specific make and model of grain head by a particular manufacturer.

Other examples of sill plate seals according to the disclosed invention may have different dimensions and/or specifications. Sill plate seals according to the disclosed invention may be made from any suitable material such as stainless steel, other metals, composite materials, and the like. The seals may be painted or coated with other materials (epoxies, plastics, composites, and the like) to improve their wear characteristics, prevent damage to the underlying sill plate surface, and the like.

While the claimed technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the claimed technology are desired to be protected.

What is claimed is:

1. A sill plate seal system for a header attachment of a combine harvester, comprising:
a triangular seal plate having a longer edge and two shorter edges, a securing through hole located near each vertex, and a bolt hole located between two vertices along the longer edge; and
a shoulder bolt having a head portion and a shoulder portion;
wherein the seal plate bolt hole is sized so as to prevent the bolt head portion from passing therethrough and to allow the shoulder portion of the bolt to pass therethrough.

2. The sill plate seal system of claim 1, further comprising a washer sized so as to allow the shoulder portion of the shoulder bolt to pass therethrough.

3. The sill plate system of claim 1 wherein the surface of the seal plate is coated with one or more of paint, epoxy, and plastic.

4. The sill plate seal system of claim 1 wherein the vertices of the triangular seal plate are rounded.

5. The sill plate system of claim 1 wherein the triangular seal plate is made from a metal which may be metallurgically secured to the sill plate.

6. The sill plate system of claim 1 wherein the metallurgical securing comprises one or more of welding, brazing, and soldering.

7. A method of securing a sill plate to a combine harvester header attachment, comprising:
providing a triangular seal plate having a longer edge and two shorter edges, a securing through hole located near each vertex, and a bolt hole located between two vertices along the longer edge;
providing a shoulder bolt having a head portion and a shoulder portion;
positioning the seal plate such that the seal plate bolt hole aligns with an existing bolt hole through the sill plate of a combine harvester header;
passing the shoulder portion of the shoulder bolt through the seal plate bolt hole and securing the shoulder bolt to the sill plate bolt hole; and
metallurgical joining the seal plate to the sill plate at each securing through hole in the seal plate.

8. The method of claim 7, wherein the metallurgical joining comprises one or more of welding, brazing, and soldering.

9. The method of claim 7, further comprising positioning a washer between the shoulder bolt head portion and the seal plate.

10. The method of claim 7, wherein the surface of the seal plate is coated with one or more of paint, epoxy, and plastic.

11. The method of claim 7, further comprising removing an existing bolt from the sill plate bolt hole prior to positioning the seal plate.

12. A sill plate seal system for a grain header attachment of a combine harvester, comprising:
a triangular seal plate having a first edge which is longer than the second and third edges, a through hole located near each vertex, and a bolt hole located along the first edge; and
a shoulder bolt having a head portion and a shoulder portion;
wherein the seal plate bolt hole is sized so as to prevent the bolt head portion from passing therethrough and to allow the shoulder portion of the bolt to pass therethrough.

13. The sill plate system of claim 12 wherein the bolt hole is an oblong slot.

14. The sill plate seal system of claim 12, further comprising a washer sized so as to allow the shoulder portion of the shoulder bolt to pass therethrough.

15. The sill plate system of claim 12 wherein the surface of the seal plate is coated with one or more of paint, epoxy, and plastic.

16. The sill plate seal system of claim 12 wherein the vertices of the triangular seal plate are rounded.

17. The sill plate system of claim 1 wherein the triangular seal plate is made from a metal which may be metallurgically fused to the sill plate.

18. The sill plate system of claim 17 wherein the metallurgical fusing comprises one or more of welding, brazing, and soldering.
